(19) United States
(12) Patent Application Publication
(10) Pub. No.: US 2009/0043868 A1
(43) Pub. Date: Feb. 12, 2009

(54) Community information exchange system and method

(76) Inventor: John Hathaway, Pittsburgh, PA (US)

Correspondence Address: ARENT FOX LLP, 1050 CONNECTICUT AVENUE, N.W., SUITE 400, WASHINGTON, DC, 20036, US

(21) Appl. No.: 12/073,790

(22) Filed: Mar. 10, 2008

Related U.S. Application Data
(60) Provisional application No. 60/905,609, filed on Mar. 8, 2007.

(51) Int. Cl. G06F 15/173

(52) U.S. Cl. 709/218

(57) ABSTRACT

Content provided directly by users, such as renters in the real estate industry, is relied on to supplement, enhance and improve the relevance of the site. The renters themselves generate the content in the form of reviews, not the apartments' management companies, for example, which provides less perceived bias in the information provided. An incentive for renters is provided to enter such a space, not only to obtain unbiased information about apartments, but also to accumulate reward points that they can then exchange against various goods or services, and to add content and accumulate points as a result. Thus, a method of user-generated exchange of community information comprises registering information about a user, recording search criteria for services sought by the user, recording feedback of the user about the services used and about service providers, and allowing the user to access feedback from other users.

This application claims priority from U.S. Patent Application No. 60/905,609, filed on Mar. 8, 2007 and titled “Community Information Exchange System and Method,” the contents of which are incorporated herein by reference in their entirety.

### BACKGROUND OF THE INVENTION

1. Field of Invention

The present invention relates to the creation of a forum of exchange and to encourage user generated content among apartment rental communities.

2. Description of Related Art

More than 11 million renters move each year in the United States, and they have a wealth of information about the apartment and the building that they have occupied. Most of the resources in the online rental industry are dedicated towards apartment managers, which pay an advertising fee to list content on such sites. While a few sites offer ratings of apartments, they generally are only ratings sites.

Although existing companies like Rent.com, Move.com and Apartments.com already provide information about, for example, apartment rental, the information that they typically display is provided by the apartment management.

Many facets of the life of a renter are routine and ongoing and would benefit an online community. Activities such as locating a moving company, ordering utilities and paying monthly rent are commonplace. Buying renters insurance and furniture are popular purchases. Like the rest of society, this group also spends money on food, clothing, travel, entertainment, charity and a variety of miscellaneous categories.

Meanwhile, beginning in the mid-nineties with Yahoo's Geocities and America Online, social networking has exploded. Today's common theme is for middle school students to begin using MySpace and to continue with it throughout high school. With such systems, each user creates a personalized home page and customizes it to his or her own taste. Friends are connected online. Pictures and music are posted, and blogs are created. Sharing is critical, and finding people is easy.

Once entering college, sites such as Facebook are introduced to these users and are used extensively to interact with friends, classmates and teachers. In the past, a freshman directory was printed and distributed to all incoming students. It contained everyone's high school senior picture and brief, basic information on the student. Now, this information is provided online. Students find friends, parties and classmates with a few clicks on the mouse of a computer. When these students graduate from college, they look for a job and probably an apartment.

Further, it is well established that one of the drawbacks of renting is that the renter, in contrast to a homeowner, doesn't build any equity in a home while paying monthly rent payments. This can lead to a tenant renting a place for many years and not having anything to show for it financially. Many merchants incorrectly categorize renters as “paycheck to paycheck,” with little or no disposable income to pursue. The fact is that many renters spend a great deal of money on a regular basis, but do not obtain any reward in return.

The past ten years have seen a dramatic change in the way in which people obtain information. This trend is particularly evident in the rental real estate market. In 1996, the standard way that a renter found an apartment or rental home was through newspaper advertising, free booklets at convenience stores and bus stops, and through driving around town either alone or with the help of a real estate agent.

Nowadays, the typical way to look for an apartment is to perform an online search starting with a search engine such as Google, and large Internet listing services, such as Rent.com, Move.com, or Apartments.com. This approach typically leads to more research on topics such as pictures, ratings, rents, schools, and the like. Finally, armed with a significant cadre of information, the renter contacts the apartment community and schedules an appointment.

As a result, currently, about 68% of renters find their apartments online. This figure has doubled over the last five years and is expected to continue to increase. Apartment Communities have responded to this shift in dramatic fashion. Online advertising spending has grown by 156% over the last five years and is expected to continue to grow.

In the mid- to late nineties, several large Internet businesses were founded to attempt to capitalize on this opportunity. However, the content of each of these Internet sites is generated by the apartment managers and communities, not by the renters themselves.

### SUMMARY OF THE INVENTION

In light of the above described problems and unmet needs, various exemplary embodiments according to this invention provide methods and systems that tap into the knowledge base of the approximately 22 million renters per year in the United States by offering that segment of the population valuable opportunities to save money and build equity towards a home purchase.

Aspects of this invention rely on content provided directly by renters to supplement, enhance and improve the relevance of the site. Unlike other players in the industry, these aspects of the present invention do not have the apartments' management companies as a customer base, but the renters themselves, which theoretically provides less bias in the information input by the renters.

Building directly from the strength and market position of social networking popularity, aspects of this invention bridge the gap once the users of the system enter the rental market. Aspects of the present invention allow members of this group to rely on each other for rental advice and content, as they have for music tastes, gaming, socializing and blogging.

Aspects of the present invention also provide an incentive for renters to enter such a space, not only to obtain unbiased information about apartments, but also to accumulate reward points that they can then exchange against various goods or services.

Aspects of the methods and systems of the present invention provide an incentive to members of the Forum to return to the Forum site (i.e., an Internet web site) regularly and to add content, and accumulating reward points as a result. Members of the Forum are able to control the types of offers they want to see and can opt in or opt out at any time.

Beginning with the renter's initial search for an apartment, renters using the Forum site are able to easily find detailed information about apartment communities, including photographs, ratings, rental rates, and availability. Much of the content on the site is user-generated content, and by relying on information to and from other renters, renters can avoid the often biased information that appears in advertisements by apartment managers. Renters can then make informed decisions on where to live based on the useful and relevant content provided by the site.

An exemplary embodiment of aspects of the present invention includes a rewards program. Similar to popular credit card rewards programs, the rental rewards program of these aspects of present invention allows tenants to accumulate rewards points based on, for example, the amount of their monthly rent payments, or based on any information they may share with other renters at the Forum site. Accordingly, through a partnership with goods and services providers, a tenant may be able to redeem these points for discounted or sometimes free goods and services.

According to another exemplary embodiment, renters may choose to join the Forum or simply browse the information made available by members of the forum. When a renter chooses to be part of the Forum by, for example, filling out an information form, the renter may then be allowed to accumulate reward points by either contributing to the content of the Forum, or simply by continuing to pay their monthly expenses. According to another exemplary embodiment, the reward points accumulated by a member when contributing to the content of the Forum may be weighted more than reward points that are accumulated simply by paying regular expenses. Thus, each member of the Forum may be assigned a password and user name at no cost, and each may be able to manage his or her own space within the Forum, also for free, highlighting preferences, setting up specific alerts, such as to be informed whenever a sale is taking place at the local clothing store via email or a text message on their cellular telephone. These members may post when certain establishments in their area are having sales, so that other members may be able to select these establishments, or add other establishments. Because the nature and quality of the Forum depends heavily on content generated by users, rewarding those members who actively contribute to the content may be given higher priority or weight that rewarding those users who simply pay their regular expenses. Accordingly, some embodiments of the present invention include three tiers of users: i) member of the Forum who contribute to the content of the Forum, ii) members of the Forum who merely pay their regular expenses, and iii) non-members who only visit the Forum site to obtain information on local communities and businesses. It should be noted that only the renters who are members may be allowed access to specific discounts or offers.

On the merchant side, embodiments of the present invention include a local merchant system to allow merchants from all over the United States to sign up and post any specials or discounts they may offer, and these specials and discounts may then be displayed to members, such as those located in the same geographic area as the merchant. Merchants may be provided a separate back-end interface through which to access the Forum and post their offers and discounts. Thus, merchants who may want to target specific customers in specific geographic areas may become merchant members of the Forum for a fee, and agree to redeem the reward points accumulated by individual Forum members with their goods and services. In some embodiments, participating merchants download software that allows access to the back-end interface of the Forum. Alternatively, merchants may be granted direct access to individual Forum members, provided the individual Forum members authorize such access. Similarly to individual Forum members, there may be two tiers of merchant members.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various exemplary embodiments of the systems and methods will be described in detail, with reference to the following figures, wherein:

FIG. 1 is an illustration of the life cycle of a typical tenant;

FIG. 2 is a flow chart illustrating features of an exemplary embodiment of the invention;

FIG. 3 is a screen shot illustrating features of an exemplary embodiment of the invention;

FIGS. 4a-c are flow charts illustrating a life cycle of a tenant, according to an exemplary embodiment;

FIG. 5 presents an exemplary system diagram of various hardware components and other features, for use in accordance with an embodiment of the present invention; and

FIG. 6 is a block diagram of various exemplary system components, in accordance with an embodiment of the present invention.

### DETAILED DESCRIPTION OF PREFERRED EMBODIMENTS

These and other features and advantages of this invention are described in, or are apparent from, the following detailed description of various exemplary embodiments.

In addition to their yearly necessities and staples, renters eventually make larger purchases such as cars, homes, and the like. Ranging from computers and high definition electronics to travel, vacations, automobiles and eventually the purchase of a home, renters tend to act like the rest of society. Merchants generally seek the opportunity to offer these renters discounts for the ability to market to them exclusively in a category and in real time. By leveraging this large base of purchasing power, members of an Internet community that provide a Forum for sharing information with respect to local merchants and services in exchange for discounts can save money on many large “big ticket” purchases.

Moving to a new apartment involves meeting neighbors and new people, along with obtaining information on local schools, businesses and social activities. Once settled in a new place, the tenant begins the repetitive monthly process of paying rent, buying food and other necessities, and paying the regular influx of bills. After settling in for a few years, the tenant typically decides to move again, on average every three years. The tenant decides to start the process all over again and find a new place to live. The process repeats itself again, with some tenants opting to move into home ownership and others continuing to rent. This may be called the “life cycle” of the tenant.

Aspects of the methods and systems of the present invention provide an incentive to members of the Forum to return to the Forum site (i.e., an Internet web site) regularly and to add content, and accumulating reward points as a result. Members of the Forum are able to control the types of offers they want to see and can opt in or opt out at any time.

Beginning with the renter's initial search for an apartment, renters using the Forum site are able to easily find detailed information about apartment communities, including photographs, ratings, rental rates, and availability. Much of the content on the site is user-generated content, and by relying on information to and from other renters, renters can avoid the often biased information that appears in advertisements by apartment managers. Renters can then make informed decisions on where to live based on the useful and relevant content provided by the site.

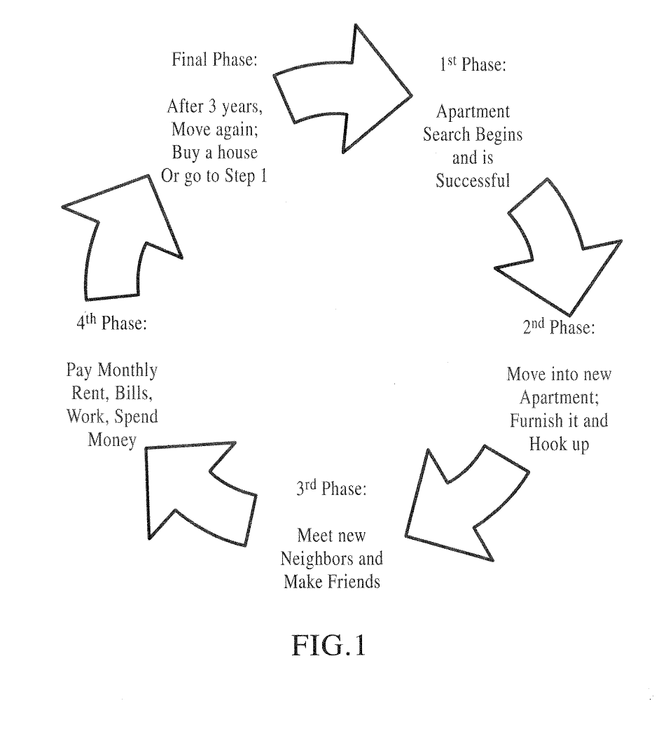

FIG. 1 is an illustration of the life cycle of a typical tenant. Once settled in and with some new acquaintances made, the tenant begins paying regular monthly bills, the most prominent and predictable of which is usually the monthly rent. Renters have notoriously been at a perceived disadvantage financially, due in part to the fact that, unlike mortgage payors, renters do not build any equity in their homes over time.

In order to address this problem, an exemplary embodiment of the present invention includes a rewards program. Similar to popular credit card rewards programs, the rental rewards program in accordance with aspects of the present invention allows tenants to accumulate rewards points based on, for example, the amount of their monthly rent payments, or based on any information they may share with other renters at the Forum site. Accordingly, through a partnership with goods and services providers, a tenant may be able to redeem these points for discounted or sometimes free goods and services.

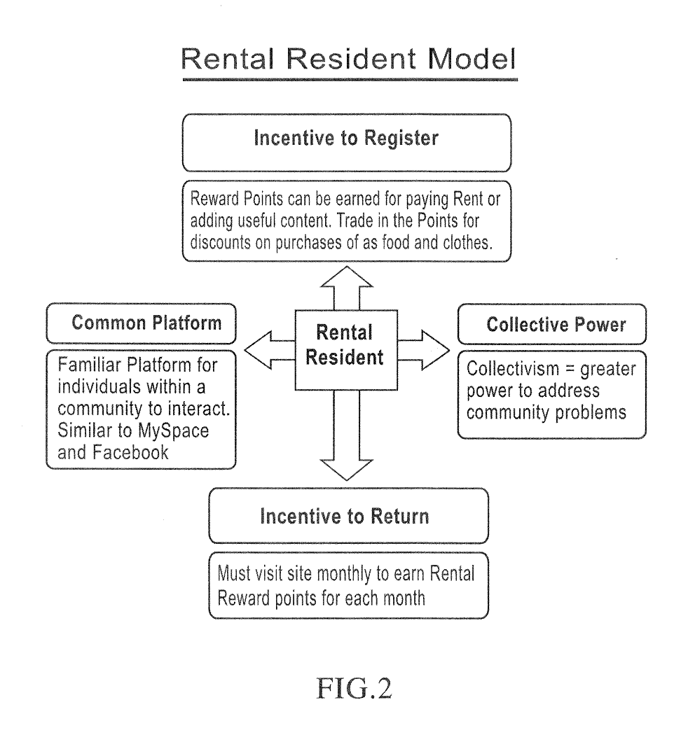

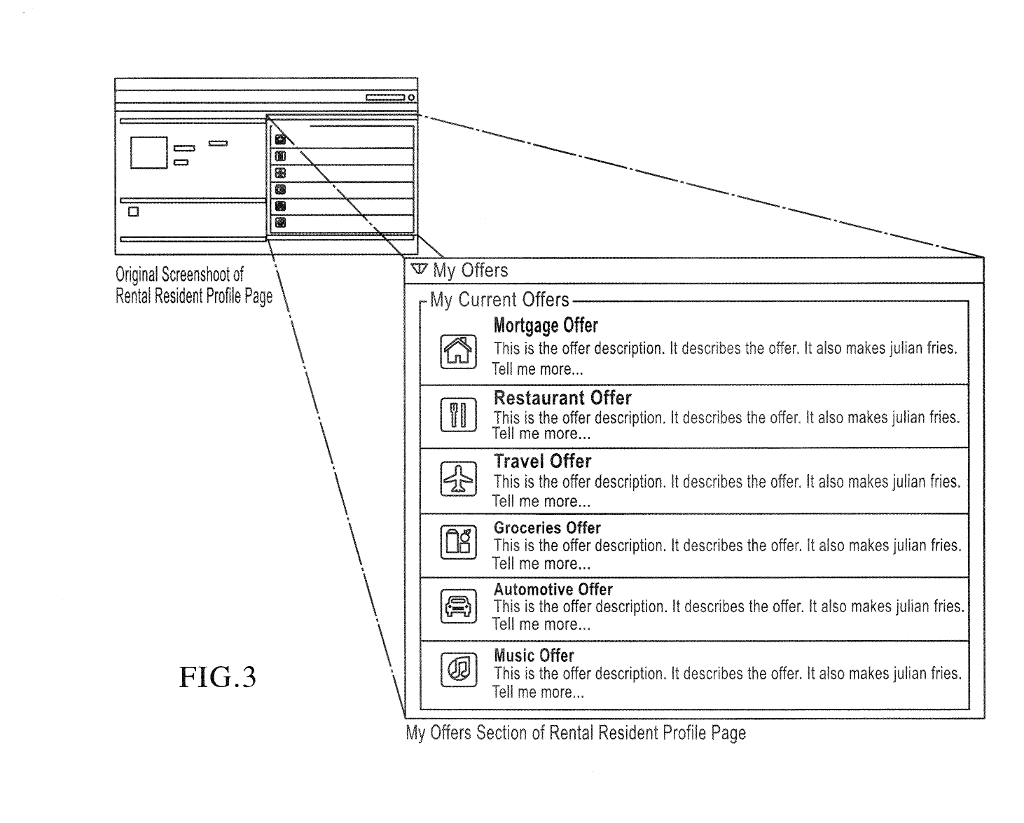

FIG. 2 is a flow chart illustrating an exemplary embodiment of the present invention. As a large, easily definable demographic, tenants have several traits and opportunities. As a whole, many tenants may purchase similar goods and services on a regular basis, such as utilities, monthly rent, cellular telephone service, cable, insurance, food, clothing, cars, vacations and ultimately a home or another lease. Thus, a tenant may benefit from, for example, the bulk buying power of a large group at negotiated rates on a variety of products, ranging in scope from free pizzas or dry cleaning, to discounts on utilities, vacations, cars, homes, and mortgages. By accumulating and redeeming rewards points, tenants who are members of the program may save hundreds or even thousands of dollars per year. For example, members can save up to 25% of a full year's rent towards the purchase of a home. These programs are easy to use and are scaleable, and each offer is subject to its own terms and conditions. An example of a screen shot of a graphical use interface (GUIS) for a rental user illustrating information provided by renters on local goods and services providers is shown in FIG. 3.

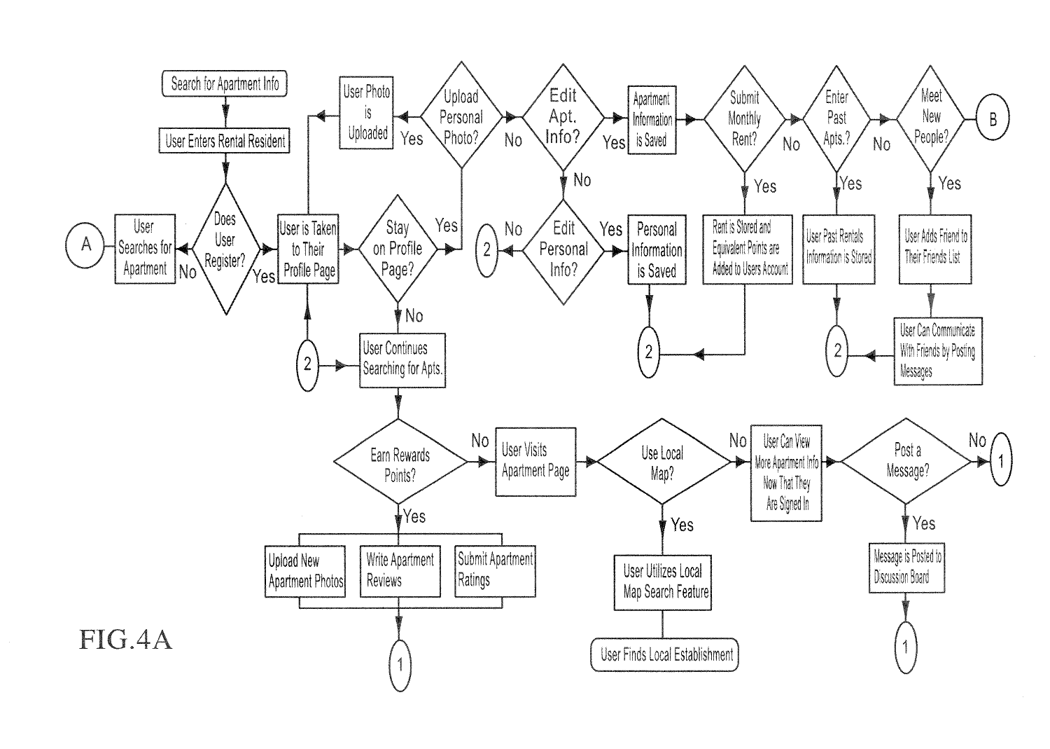

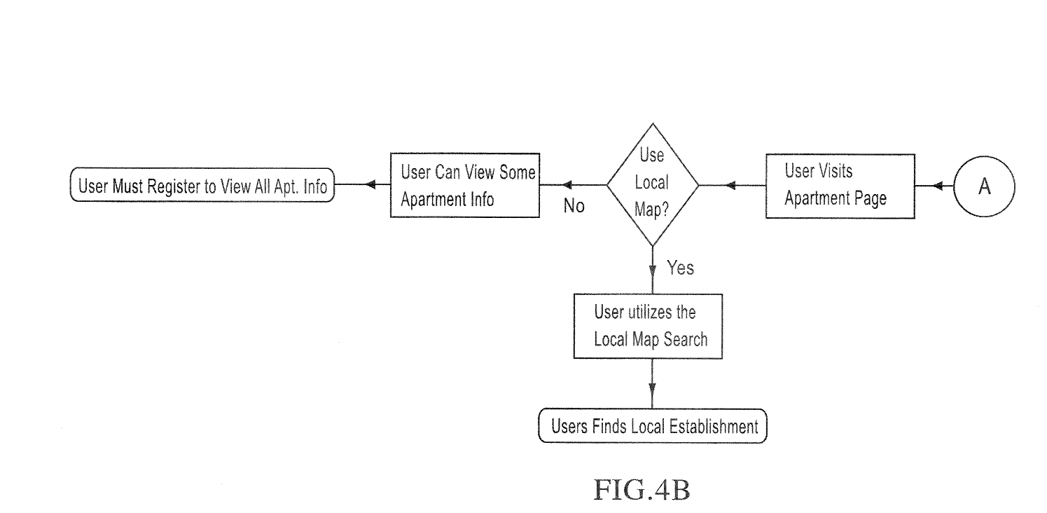

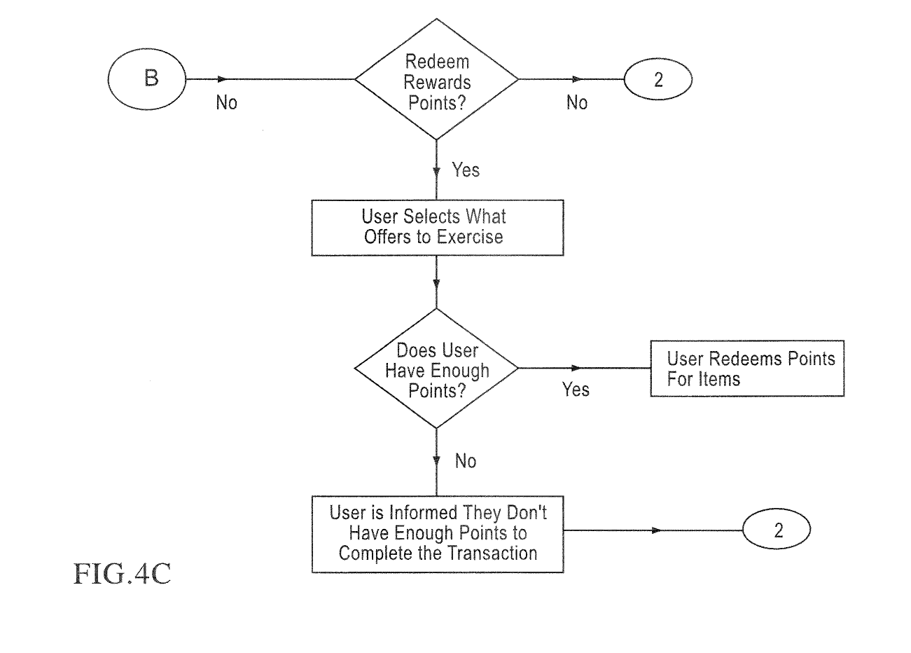

FIGS. 4a-c are flow charts illustrating operation of aspects of the present invention, according to an exemplary embodiment. For example, a system for rating and reviewing local establishments, such as restaurants, stores, bars, and the like, may be established. Thus, renters may be allowed to find existing establishments or add their own, then write short reviews about them and give them a star rating. Doing so will result in participating uses acquiring reward points, which can be used to obtain further goods or services. These ratings and reviews may be posted on a website so that other renters can view them.

According to another exemplary embodiment, renters may choose to join the Forum or simply browse the information made available by members of the forum. When a renter chooses to be part of the Forum by, for example, filling out an information form, the renter may then be allowed to accumulate reward points by either contributing to the content of the Forum, or simply by continuing to pay their monthly expenses. According to another exemplary embodiment, the reward points accumulated by a member when contributing to the content of the Forum may be weighted more than reward points that are accumulated simply by paying regular expenses. Thus, each member of the Forum may be assigned a password and user name at no cost, and each may be able to manage his or her own space within the Forum, also for free, highlighting preferences, setting up specific alerts, such as to be informed whenever a sale is taking place at the local clothing store via email or a text message on their cellular telephone. These members may post when certain establishments in their area are having sales, so that other members may be able to select these establishments, or add other establishments. Because the nature and quality of the Forum depends heavily on content generated by users, rewarding those members who actively contribute to the content may be given higher priority or weight that rewarding those users who simply pay their regular expenses. Accordingly, some embodiments of the present invention include three tiers of users: i) member of the Forum who contribute to the content of the Forum, ii) members of the Forum who merely pay their regular expenses, and iii) non-members who only visit the Forum site to obtain information on local communities and businesses. It should be noted that only the renters who are members may be allowed access to specific discounts or offers.

It should be noted that the Forum can be used not only by renters, but by anybody who purchases goods or services. The Forum may be a source of information on the type of car to buy, the latest movie, sports events, concerts, and the like. Accordingly, a Forum member may log in to the Forum and look for what other members think of any of these products, in addition to what members may think of local apartment complexes.

On the merchant side, embodiments of the present invention include a local merchant system to allow merchants from all over the United States to sign up and post any specials or discounts they may offer, and these specials and discounts may then be displayed to members, such as those located in the same geographic area as the merchant. Merchants may be provided a separate back-end interface through which to access the Forum and post their offers and discounts. Thus, merchants who may want to target specific customers in specific geographic areas may become merchant members of the Forum for a fee, and agree to redeem the reward points accumulated by individual Forum members with their goods and services. In some embodiments, participating merchants download software that allows access to the back-end interface of the Forum. Alternatively, merchants may be granted direct access to individual Forum members, provided the individual Forum members authorize such access. Similarly to individual Forum members, there may be two tiers of merchant members.

First tier merchants may want to have the ability to access specific classes of Forum members and target them with offers of discounts or of new services, either directly via email or by postings on those Forum members' Forum page. These merchants are allowed to make instantaneous postings of offers or discounts. Accordingly, these merchants may adjust (e.g., in a graphical user interface (GUIS)) their advertising effort in real time, and also respond in real time to changes to the goods they currently have in stock. For example, restaurants may post or update their Thursday specials on Thursday morning, instead of at the beginning of the week or of the month, as is currently often the case. First tier merchants are actually able to know what percentage of members have read their offers in real time, and what percentage of these members have actually responded positively to their offers, also in real time. Access for first tier merchants may be implemented by a specific interface for merchants, with access level controlled by logging on using a password, similarly to members, but via an interface made available to merchants that is different than the interface made available to individual members of the Forum.

Merchants who operate on a larger scale, such as computer manufacturers or retail chains, may also provide information on their latest sales in real time, and may even target individual geographic areas with specific sales or offers. Similarly to individual members, merchants may be able to manage their own merchant interface, or web page, based on their specific needs, also for a fee. Merchants may be given the choice of paying for the service as they use it, or paying on a monthly fee basis, allowing unlimited access.

Second tier merchants may be merchants that only want to be part of the Forum as part of their advertising effort. These merchants may also be provided a back-end interface, different than the one provided to first tier merchants, and allowing second tier merchants to merely post advertising. Second tier merchants may also be provided a password to post and look at their advertisement in real time. Second tier merchants, however, may also agree to redeem the reward points accumulated by individual Forum members for products and services.

In order to ensure the integrity of the nature of information exchanged, either between individual Forum members, or between merchants and Forum members, security features may be added to the Forum to eliminate any attempts to bias the information available on the Forum. For example, if a specific service provider is consistently rated at a low level, and one individual member unexpectedly rates that service to provide at a disproportionately high level, then that individual member may be flagged, and the information provided by that member may be more closely monitored.

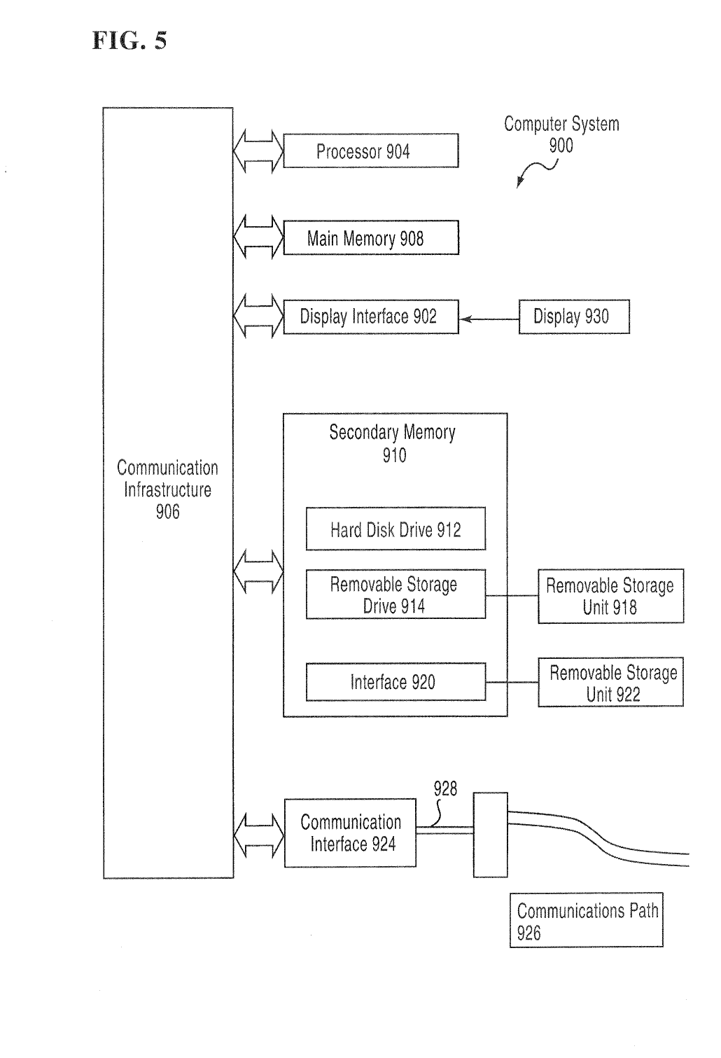

FIG. 5 presents an exemplary system diagram of various hardware components and other features, for use in accordance with an embodiment of the present invention. The present invention may be implemented using hardware, software, or a combination thereof and may be implemented in one or more computer systems or other processing systems. In one embodiment, the invention is directed toward one or more computer systems capable of carrying out the functionality described herein. An example of such a computer system 900 is shown in FIG. 5.

Computer system 900 includes one or more processors, such as processor 904. The processor 904 is connected to a communication infrastructure 906 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data. In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

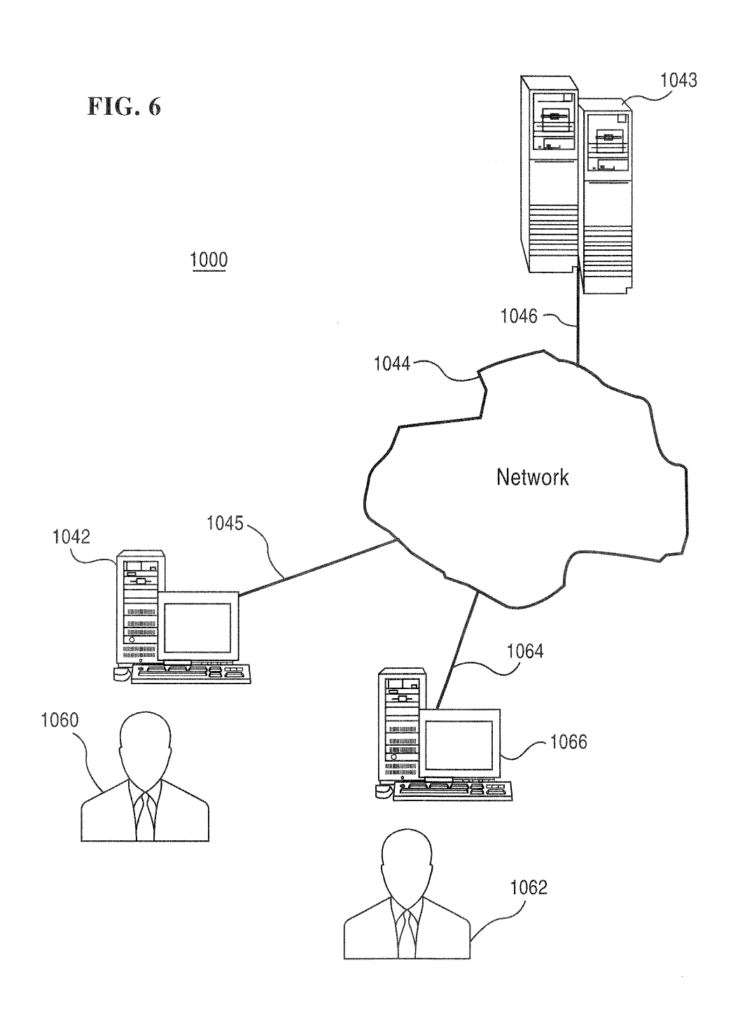

FIG. 6 is a block diagram of various exemplary system components, in accordance with an embodiment of the present invention. FIG. 6 shows a communication system 1000 usable in accordance with the present invention. The communication system 1000 includes one or more accessors 1060, 1062 (also referred to interchangeably herein as one or more “users”) and one or more terminals 1042, 1066. In one embodiment, data for use in accordance with the present invention is, for example, input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another embodiment, the method and system of the present invention operate in a stand-alone environment, such as on a single terminal.

The Appendix contains a brief overview of an exemplary rental resident system and method, in accordance with an embodiment of the present invention.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

### EXECUTIVE SUMMARY

To address the needs of the vast residential rental market, Rental Resident has developed a proprietary model to effectively capture and cultivate the renter's interest and loyalty throughout the Life Cycle of rental living. By providing renters with access to unbiased information about apartment communities provided by the tenants themselves, Rental Resident will build a strong, trusted brand on which renters will rely. The backbone of the content will revolve around the latest Social Networking technologies, which have already gained wide market acceptance through the likes of MySpace, Facebook and YouTube. To further increase User loyalty, the Company has created a Rental Rewards program, which is expected to significantly impact overall site appeal to its Users.

By creating a Rewards program that would allow renters to earn points every month when entering their rent payment, the Company could accomplish two important things. First, the points could be earned and accumulated over time towards the purchase of a home by trading them in for discounts on home prices through commission rebates and by trading them in to buy down rates or closing costs on mortgages. The Company immediately partnered with national firms in each are enabling the Company to fulfill these Rewards offers. This was the first benefit of the program, helping the renter leave the Rental Cycle and begin the Homeowner Cycle. The Second, and potentially more important feature of the Rewards program is that it is recurring in nature. In other words, the renter must return to the site on a monthly basis to enter rent for the month and receive Rewards points. This creates a well defined brand in the mind of the consumer and helps to integrate the Company into the Life Cycle of the Tenant.

Rental Resident's target market is the vast group of 33 million renters in the United States. Roughly ⅓ of that group initiates a residential move each year, spending an estimated $2 Billion per year in the process. The major opportunities present in the segment today are:
The majority of prospective renters are finding information online. Although existing companies like Rent.com, Move.com and Apartments.com have already successfully entered this space, the information that they display is similar in that it is directly provided by the Apartment Management. Rental Resident will rely on content provided directly by renters to supplement and enhance and improve the relevance of the site. Unlike other players in the industry, Rental Resident will not have the Apartments Companies as a Customer base, therefore site information will be less biased.
The renters at the entry point of the Life Cycle are comfortable with Social Networking. Building directly from the strength and market position of Social Networking leaders such as MySpace and Facebook, Rental Resident expects to bridge the gap once the Facebook crowd enters the rental market on their own. The assumption is that the group will rely on each other for rental advice and content, as they have practiced for the last ten years in their music tastes, gaming, socializing and blogging.
Certain aspects of the rental Life Cycle are recurring and predictable. Many facets of the life of the renter are routine and ongoing. Activities such as locating a moving company, ordering utilities and paying monthly rent are commonplace. Buying renters insurance and furniture are other popular purchases. Like the rest of society, this group also spends money on food, clothing, travel, entertainment, charity and a variety of miscellaneous categories. By partnering with merchants at each of these levels through the Rental Rewards program, Rental Resident intends to bring valuable savings to its membership base.

The automated, scaleable technology built by Rental Resident will enable an enriching user experience during all phases of the Life Cycle. Content will be acquired through a combination of partnerships and Social Networking. Membership levels should grow through the display of unique content available exclusively to members. Loyalty and brand awareness are anticipated to be accomplished by implementing a strong Consumer loyalty program known as Rental Rewards.

### HIGHLIGHTS

### Market Forces Driving Need for Rental Site Focusing on User Generated Content

The Web 2.0 generation has quickly migrated towards reliance on User Generated Content. Diverse companies and offerings such as YouTube, Wikipedia, Flickr, Ebay, Google Base, Linux, Craig's List and ApartmentRatings are all built around the concept of User Generated Content. By contributing small pieces of content over time, Users are able to benefit from the vast collective knowledge base of over 33 million renters nationwide. Renters are finding most of the information that they desire online, and will demand unbiased content as this market matures.

### Market is Virtually Untapped

Most of the resources in the online rental industry are dedicated towards persuading Apartment Managers to pay an advertising fee to list content on a site. While a few sites offer ratings of apartments, they've isolated themselves into just being ratings sites. More than 11 million renters move each year, and they have plenty information sources at that time. The goal of Rental Resident is to tap into the knowledge base of the 22 million renters per year that don't move. By offering that segment valuable opportunities to save money and build equity towards a home purchase, the Company expects that the group will be more likely to add content and to use the Company's services when preparing for their next move. The opportunity is in the fact that once a renter finds a new place and moves in, most companies in the industry ignore the renter until three years later when they're ready to rent again. Rental Resident will maintain a relationship with the renter throughout the Life Cycle.

### Social Networking is Growing Significantly

Beginning in the mid nineties with Yahoo's Geocities and America Online, social networking has exploded over the past ten years. Today's common theme is for middle school students to begin using MySpace and to continue with it throughout high school. Each user creates a personalized home page and customizes it to his or her own tastes. Friends are linked in. Pictures and music are posted and blogs are created. Sharing is critical and finding people is easy. Once entering college, Facebook is introduced and is used extensively to interact with friends, classmates and teachers. In the old days, a freshman directory was printed and distributed to all incoming students. It contained everyone's high school senior picture and brief, boilerplate information on the student. Now, it is all happening online. Students find friends, parties and classmates with a few clicks. When these students graduate from college, they'll look for a job and probably an apartment. By offering this group a familiar platform and interface in which to find information recommended by their peers, Rental Resident expects to change the way Apartments are selected.

### Need for Significant Monetary Savings by Renters

It is well established that one of the drawbacks of renting is that the renter, in contrast to a homeowner, doesn't build any equity while paying their monthly rent payment. This can lead to a tenant renting a place for many years and having nothing to show for it financially. Many merchants incorrectly categorize renters as “paycheck to paycheck” with little or no disposable income to pursue. The fact is that many renters spend a great deal of money on a regular basis. By establishing a Loyalty program for renters, known as Rental Rewards, the Company will help renters save money on many of their purchases.

### Rental Resident Provides a Comfortable, Trustworthy Platform to Deliver Solutions

The Company has modeled its Social Networking Interface after the highly successful sites My Space and Facebook. By providing a known platform, User adoption and acceptance should be more pronounced. With a fast, free registration, and exclusive content available only to members, Rental Resident expects to continue converting visitors to members at a strong rate. User Generated Content combined with a large, active membership base has proven to be the right formula for many of today's most popular companies. The solutions and services provided by Rental Resident will be ideal and timely for this large, highly fragmented industry.

### Renters Eventually Purchase Big Ticket Items

In addition to their yearly necessities and staples, renters eventually make big ticket purchases. Ranging from computers and high definition electronics to travel, vacations, automobiles and eventually the purchase of a home, this group tends to act just like the rest of society. This audience of geographically identifiable renters is easily reachable in real time, as they manage their Rewards Points and engage in Social Networking. Merchants relish the opportunity to offer them discounts for the ability to market to them exclusively in a category and in real time. By leveraging this enormous base of purchasing power, Rental Resident can help it members save money on many big ticket purchases.

Company Established Relationships and is Working with Industry Leaders

The Rental Rewards program will propel members to return to the site regularly and to add content. To ensure that the Rewards points can be redeemed for valuable savings, the Company has contracted with several large nationwide banks, mortgage companies, real estate companies, travel companies, local merchant advertisers, and other partners. These relationships will provide relevant, exclusive offers to Rental Resident members in real time. Members will be able to control the types of offers they want to see and can opt in or out at any time.

Within the Rental market, tenants are rapidly beginning to fill their needs online, and Rental Resident expects to become the trusted source for handling these needs. It is now routine for tenants to conduct most of their rental research online, and to be armed with information before the initial visit.

Once a renter finally finds and rents an apartment, they're often burdened with stressful concerns such as ordering or transferring utilities, obtaining new renters insurance, buying new furniture, and finding a moving company.

In addition to these initial requirements, moving to a new apartment involves meeting neighbors and new people along with getting to know the local schools, businesses and social activities. Once settled in to a new place, the tenant begins the repetitive monthly process of paying rent, buying food and other necessities, and paying the regular influx of bills.

After settling in for a few years, the tenant typically decides to move again. On average every three years, another move is made. The tenant decides to start the process all over again and find a new place to live. The process repeats itself again, with some tenants opting to take the plunge into home ownership and others continuing to rent. This is what Rental Resident has coined “The Life Cycle of the Tenant”.

To better serve and understand this Life Cycle, the Company has developed a proprietary core technology and product that directly addresses the needs of these tenants. Rental Resident's proprietary, automated technology easily handles the entire process.

Beginning with the Renter's initial search for an apartment, Rental Resident provides the most vast and unbiased Rental content online. Renters using the site are able to easily find detailed information about apartment communities, including photos, ratings, rents, and availability. Much of the content on the site is what's known as “User Generated Content” which means that it has been provided by the Users themselves. By relying on information from their peers, Renters can avoid the often biased information that appears in advertisements.

The Renter makes an informed decision on where to live based on the useful and relevant content provided by the site. That's where the Life Cycle begins. It then flows to the logistics of the move itself. To facilitate the actual moving process, Rental Resident has negotiated bulk deals on behalf of tenants for discounts or benefits on moving, utilities, furniture and insurance.

Once in their new building, Rental Resident helps the new Tenant make new acquaintances at their own speed and on their own timetable. Modeled after the highly successful social networking sites MySpace.com and Facebook.com, Rental Resident allows Tenants to form online communities and to interact easily and comfortably on their own terms.

### The Life Cycle of the Tenant

Finally settled in and with some new acquaintances made, the Tenant begins to get back to the grind of working and paying the regular monthly bills. The most prominent and predictable of which is usually the monthly rent. Renters have notoriously been at a perceived disadvantage financially due to the fact that unlike paying a mortgage, rental payments don't build any equity over time.

To address this dilemma, Rental Resident created the Rental Rewards program. Similar to popular credit card rewards programs, the Rental Rewards program allows Tenants to accumulate Rewards points based upon their monthly rent payments.

Through a completely automated system in partnership with National Banks, Real Estate Companies, Travel Companies, and Local Merchants, Rental Resident enables the Tenant to redeem these points for discounted or sometimes free goods and services.

These items vary in nature from day to day items like free or discounted pizza and dry cleaning, to larger ticket items like discounted vacations, to home purchases and mortgages.

The unbiased apartment related content initially draws Users to Rental Resident, but the success of the Social Networking and the Rewards program will keep them coming back.

### Trends

The past ten years have seen a dramatic change in the way in which people obtain information. This trend is particularly evident in the Rental Real Estate market.

In 1996 the standard way that a Renter found an apartment or rental home was through newspaper ads, free booklets at convenience stores and bus stops, and through driving around town either alone or with the help of a real estate agent.

Now the typical way is an online search starting with Google and large Internet Listing Services such as Rent.com, Move.com, and Apartments.com. This typically leads to more research on topics such as pictures, ratings, rents, schools, etc. Finally, armed with a significant cadre of information, the Renter will contact the apartment community and schedule an appointment. Currently 68% of Renters went online to find their apartment. This figure has doubled over the last five years and is expected to continue to increase.

Apartment Communities have responded to this shift in dramatic fashion. Online advertising spend has grown 156% over the last five years and is expected to grow by an additional 20% each of the next five years.

In the mid to late nineties, several large Internet businesses were founded to attempt to capitalize on this opportunity. The largest of which, Rent.com, was acquired by Ebay two years ago for $440 million in cash. The most recent, MyNewPlace.com, was formed less than 1 year ago and has raised over $20 million in capital to date. Some others like Move.com and Apartments.com are estimated to have valuations in the hundreds of millions of dollars. The common ground on these sites is that they all have content provided directly by management, and little or no content provided by the actual Tenants.

Content provided by Tenants is the backbone of Rental Resident and is known as “User Generated Content”. This concept has been successfully implemented by YouTube, WikiPedia, Linux, and in the Apartment space by ApartmentRatings.com.

### The Evolution of the Rental Experience

| Old Rental Experience | New Rental Experience |
|---|---|
| Look in Newspaper Classified | Search Online using Vertical |
| Ads or Free Rental Books | Search Engines |
| Real Estate and Leasing | Get Rewards yourself for |
| Agents get Commissions | Searching Online |
| Call Leasing Office for info | View Info Online and Send |
| and appointment | E-Mail for appointment |
| Drive to Building for a Tour | Take the Online Virtual Tour |
| See pictures and read | See real pictures and get real |
| testimonials in biased | ratings and reviews from |
| Corporate Marketing material | existing and Past tenants |
| Sign a lease and pay | Get paid to sign a lease |
| Spend time calling Movers and | Get an instant quote online |
| hope for good rates | |
| Call to disconnect old Utilities | Do it all at once online and |
| and order new ones | save money and time |
| Move in and get visited by | Search MySpace and Facebook |
| Welcome Wagon | to meet new friends |
| Monthly Rent payments Don't | Save Rewards Points towards |
| build any equity | the Purchase of a home |
| Be overlooked by Merchants | Be targeted by Merchants |
| Because you “Rent” | Because you are savvy |
| Traditional Practices | Rental Resident |

As evidence by the table above, the renter is gaining access to more and more information. The playing field has leveled, and the rental world has flattened. In the same way that author Thomas Friedman argues the point in his bestselling book, The World is Flat, the Company believes that renters armed with information become more efficient. Efficiency creates better pricing and eliminates waste. In this specific case, some examples of waste or inefficiencies that may begin to erode are: high priced newspaper and magazine advertisements, locator fees, service fees, and real estate and mortgage commissions to name a few. These trends have all occurred over the last ten years and are projected to continue indefinitely.

Another emerging trend has occurred even more recently. The concept of Social Networking has exploded with the popularity of online sites like MySpace and Facebook. Both companies boast of multi billion dollar valuations and have been built on the concept of targeting a certain demographic and creating a User base. The Company expects that it will be well positioned as college graduates emerge into the workforce and look for apartments online. By providing a comfortable User Interface for this group and by building trusted content, the Social Networking aspect of Rental Resident should help to organically drive Company User and revenue growth on a recurring basis.

### Rental Rewards

Rewards programs are clearly a proven marketing model that works when implemented properly. Rental Resident believes that the concept will be just as successful in the Rental world and that the Company is creating and defining a market niche with first mover advantages. The program is easily scaleable and adaptable.

Another trend that has developed over the last ten years is the proliferation of national affiliate programs. These programs allow Internet Sites like Rental Resident to easily partner with well known trusted brands on a revenue share basis without any upfront costs or investments. This gives companies like Rental Resident the ability to offer benefits to our User base without costly overhead.

By sharing revenue stream from these products and services with the User, Rental Resident is able to offer the Tenant the leverage and purchasing power of a large group much in the way that a credit union or warehouse club has exclusive member pricing.

The service itself is a free, state of the art online community accessible at www.RentalResident.com. Visitors arrive on the site through a combination of direct entry, organic and paid search, and through channel partners and affiliates. Once on the site they are able to view some of the content without registering, and are able to add content and see unlimited content by completing a simple registration.

A common entry point starts with a Renter going online to search for an apartment. Through the methods described above, a visitor arrives on Rental Resident's site.

After an initial prompt to register, the User is able to view detailed information on apartments and cities nationwide. In many cases this includes pictures, rents, availability, ratings and reviews and local neighborhood information.

Some Users will obtain their desired information and exit the site. Others will navigate through and around the site to engage in the social networking features or to take advantage of the Rental Rewards program. Over time, the amount of Registered Users returning to the site to utilize these features should grow exponentially.

Returning visitors are one of the keys to increasing the Company's growth prospects. As the Returning Users come back to the site and spend more time socializing, utilizing discussion boards and redeeming their Rental Rewards, the Company and the brand will gain additional credibility.

In addition to implementing a strong Customer Relationship Management (CRM) program, Rental Resident will need to ensure a constant flow of new User Generated Content and a valuable Rewards program.

To maximize the likelihood that both initiatives will succeed, the Company intends to involve the Renter in much of the process. This will initially include obtaining their input in the form of feedback opportunities, blogs, surveys and contests. Later, it may include giving them a limited voice in the direction of the Company with regard to Content and Rewards programs. The goal is to find a way to deliver exactly what the Renters want, in a scaleable and cost effective manner.

A steady stream of Returning visitors should allow the Renter to build a sense of comfort and trust in Rental Resident. The opportunity at this point is to become entrenched in the “Life Cycle of the Tenant”, and to service them accordingly.

As a large, easily definable demographic, these Tenants have several traits and opportunities. As a whole, many of them purchase similar goods and services on a regular basis. This includes utilities, monthly rent, cell phones, cable, insurance, food, clothing, cars, vacations and ultimately a home or another lease.

By establishing a relationship and identity with the Renter over time, Rental Resident will be well positioned to capture their attention at the time of their next purchase. By offering a Rental Rewards program that helps offset the costs of theses purchases on a regular basis, the Company builds trust and loyalty.

The Renter is benefiting from the bulk buying power of a large group at negotiated rates. The possibilities on this front are endless, but will initially rely on exclusive offers from strategic partners.

The Rental Rewards program will initially be the epicenter of the strategy. The Company has entered into several strategic partnerships to provide free or discounted services to Rental Resident members.

These programs range in scope from free pizzas or dry cleaning, to discounts on utilities, vacations, cars, homes, and mortgages. By accumulating and redeeming their Rental Rewards points, members will save hundreds or even thousands of dollars per year. Under one program, members can save up to 25% of a full year's rent towards the purchase of a home. These programs are easy to use and are scaleable, and each offer is subject to its own terms and conditions.

A gap clearly exists between the time that a Tenant finds an apartment online and the three years until they make another move. During the three year rental period, there will be many competing messages vying for the Resident's attention.

Large companies such as Rent.com, Move.com and others will market to the Resident, presenting new places to potentially rent. Cable, phone, travel and credit card companies will target the Resident using traditional media, direct mail and Internet banner ads. Local merchants will reach Residents through customary local newsprint and Val-Pak type ads. On the social networking side, sites like MySpace.com and Facebook.com will seek the attention of and input from Residents.

To address competition from these large and established companies, Rental Resident expects to initially rely on two key advantages. The primary point of differentiation will be gathering, organizing and displaying relevant and unique “User Generated Content”.

One model with partial similarity of Rental Resident has been successfully implemented in other verticals by MySpace, Facebook, YouTube, Ebay, CitySearch, Yahoo Movies, etc. In the Rental Vertical it has been successfully employed by ApartmentRatings.com.

While User Generated Content is enough to differentiate the Company, actually getting the Users to contribute content is the real challenge. This leads to the second point of differentiation.

To help establish and promote the Rental Resident brand, and to give Users a benefit for adding valuable content, the Company has created a Rental Rewards Points program. The model is similar to credit card or airline miles, enabling the Tenant to earn points for certain activities.

These points can be redeemed towards free or discounted goods and services that are relevant to the Tenant during the three year “Life Cycle”. The Rewards model is widely accepted and understood across other verticals.

### Technology

Rental Resident has created and completed its own proprietary code based on the latest Web 2.0 standards. Built in ASP.net, and utilizing AJAX and cutting edge mapping API's, the site provides all of the interactive tools and features that savvy web users have come to expect.

The site's code and architecture are easily and seamlessly upgradeable as newer technologies may emerge. The site is remotely hosted on powerful dedicated servers operating with 99.9% uptime guarantees. Rental Resident built and maintains its own back end admin system and uses custom integrated CRM solutions.

What is claimed is:

1. A method of user-generated exchange of community information, comprising:
registering information about a user;
recording search criteria for services sought;
recording feedback of the user about services used and about service providers;
allowing the user to access feedback from other users on at least one of the sought services, the used services and the service providers; and
granting points to the user for at least one of searching the services sought and recording the feedback about the services used and about the service providers.

2. The method of claim 1, wherein one of the services sought and the services used comprise home rental services.

3. The method of claim 1, wherein the points are redeemable for consumer goods and services.

4. The method of claim 2, wherein the search criteria are at least one of rent, square footage, amenities, and age of the home rental.

5. The method of claim 2, wherein the feedback is an apartment review.

6. The method of claim 1, wherein the user can access and edit the user registered information.

7. The method of claim 1, wherein the search criteria are stored in a data repository.

8. The method of claim 1, wherein the points are granted proportionally to the services used.

9. The method of claim 4, wherein the points are granted proportionally to the rent paid.

10. The method of claim 2, further comprising:
allowing the user to at least one of locate the home rental on a map and obtain one or more pictures or video representations of the home rental.

11. The method of claim 1, further comprising:
allowing the user to exchange points with other users.

12. The method of claim 1, further comprising:
allowing the service providers to post at least one of advertisement information, promotions and discounts.

13. The method of claim 12, wherein the information posted by the service providers is accessible by the user.

14. The method of claim 1, wherein the service providers comprise rental companies.

15. The method of claim 1, wherein various tiers of services providers can directly contact various tiers of users.

16. A system for exchanging user-generated community information, the system comprising:
means for registering information about a user;
means for recording search criteria for services sought;
means for recording feedback of the user about services used and about service providers;
means for allowing the user to access feedback from other users on at least one of the sought services, the used services and the service providers; and
means for granting points to the user for at least one of searching the services sought and recording the feedback about the services used and about the service providers.

17. A system for exchanging user-generated community information, the system comprising:
a processor;
a user interface functioning via the processor; and
a repository accessible by the processor;
wherein information about a user is registered;
search criteria for services sought are recorded;
feedback of the user about services used and about service providers is recorded;
the user is allowed to access feedback from other users on at least one of the sought services, the used services and the service providers; and
points are granted to the user for at least one of searching the services sought and recording the feedback about the services used and about the service providers.

18. The system of claim 17, wherein the processor is housed on a terminal.

19. The system of claim 18, wherein the terminal is selected from a group consisting of a personal computer, a minicomputer, a main frame computer, a microcomputer, a hand held device, and a telephonic device.

20. The system of claim 17, wherein the processor is housed on a server.

21. The system of claim 20, wherein the server is selected from a group consisting of a personal computer, a minicomputer, a microcomputer, and a main frame computer.

22. The system of claim 20, wherein the server is coupled to a network.

23. The system of claim 21, wherein the network is the Internet.

24. The system of claim 22, wherein the server is coupled to the network via a coupling.

25. The system of claim 24, wherein the coupling is selected from a group consisting of a wired connection, a wireless connection, and a fiberoptic connection.

26. The system of claim 17, wherein the repository is housed on a server.

27. The system of claim 26, wherein the server is coupled to a network.

28. A computer program product comprising a computer usable medium having control logic stored therein for causing a computer to exchange user-generated community information, the control logic comprising:
first computer readable program code means for registering information about a user;
second computer readable program code means for recording search criteria for services sought;
third computer readable program code means for recording feedback of the user about services used and about service providers;
fourth computer readable program code means for allowing the user to access feedback from other users on at least one of the sought services, the used services and the service providers; and
fifth computer readable program code means for granting points to the user for at least one of searching the services sought and recording the feedback about the services used and about the service providers.
